(19) United States
(12) Patent Application Publication
(10) Pub. No.: US 2008/0187321 A1
(43) Pub. Date: Aug. 7, 2008

(54) OPTICAL TRANSCEIVER MODULE

(75) Inventor: Atsushi KAWAMURA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/937,752

(22) Filed: Nov. 9, 2007

(30) Foreign Application Priority Data
Feb. 7, 2007 (JP) 2007-028551

(51) Int. Cl. H04B 10/00

(52) U.S. Cl. 398/139

(57) ABSTRACT

An optical transceiver module of the present invention includes: a light emitting device; a photodetector; and a shielding member covering the photodetector and having a hole for providing an optical path for a received beam incident to the photodetector; wherein the received beam incident to the photodetector forms an angle of less than 90 degrees with respect to a beam emitted from the light emitting device.

### BACKGROUND OF THE INVENTION

1. Field of the Invention

The present invention relates to an optical transceiver module, and more particularly to an optical transceiver module suitable for use in optical communications.

2. Background Art

Optical subscriber terminals for FTTH (Fiber to the Home) networks use an optical transceiver module that allows bidirectional transmission over a single optical fiber. Japanese Laid-Open Patent Publication No. 2004-264659 discloses such an optical transceiver module, which is characterized as follows. The module is a hermetically sealed package containing a light emitting device (or laser diode) and a photodetector (or photodiode). A light beam of one wavelength is emitted from the light emitting device and coupled into the optical fiber, while another light beam of a different wavelength is emitted from the optical fiber and coupled into the photodetector. These two light beams of different wavelengths are combined/separated (or muxed/demuxed) using the same lenses and diffractive optical elements. This configuration enables single-fiber bidirectional communications. Other conventional art includes Japanese Laid-Open Patent Publication No. 3-289826 (1991), 59-128508 (1984), 2001-345475, and 2000-89065.

In an optical transceiver, the power ratio of the electrical signal input to the light emitting device relative to the electrical signal output from the photodetector is high (approximately 50 dB). Therefore, the electrical signal output from the photodetector tends to be affected by the electrical signal input to the light emitting device, resulting in interference called “crosstalk.” This problem of crosstalk is more significant in the case of single-package optical transceiver modules containing both a light emitting device and a photodetector, since these components are disposed in close proximity. To reduce crosstalk, the photodetector may be covered with or enclosed within a shielding member (a grounded metal member). This prevents external signals from reaching the photodetector. However, adding such a shielding member requires extra space in the module.

### SUMMARY OF THE INVENTION

The present invention has been devised to solve the above problems. It is, therefore, an object of the present invention to allow a single-package optical transceiver module containing a light emitting device and a photodetector to exhibit reduced crosstalk without increasing its component mounting space and hence its size, which leads to easy mounting of the device.

According to one aspect of present invention, an optical transceiver module include a light emitting device, a photodetector, and a grounded metal member covering the photodetector and having a hole for providing an optical path for a received beam. The optical path extending between a light receiving point of the photodetector and a predetermined point along an optical path traveled by a beam emitted from the light emitting device. The optical path extending between the light receiving point and the predetermined point forms an angle of less than 90 degrees with respect to the optical path traveled by the beam emitted from the light emitting device.

According to another aspect of the present invention, an optical transceiver module include a metal pin through which a light emitting device receives an input signal, and a metal pin through which a light-receive-side signal passes. The metal pin through which the light emitting device receives the input signal and the metal pin through which the light-receive-side signal passes penetrate through a metal stem. The circumferential surface of the metal pin through which the light emitting device receives the input signal is covered with a thicker material than the circumferential surface of the metal pin through which the light-receive-side signal passes.

Other and further objects, features and advantages of the invention will appear more fully from the following description.

### BRIEF DESCRIPTION OF THE DRAWINGS

FIG. 1 is a diagram illustrating an optical transceiver module according to a first embodiment of the present invention;

FIG. 2 is a diagram showing an exemplary configuration in which the optical transceiver module shown in FIG. 1 is used for optical communications;

FIG. 3 shows an optical transceiver module of the second embodiment;

FIG. 4 is a diagram showing an optical transceiver module of the third embodiment; and

FIG. 5 is a diagram showing an optical transceiver module of the fourth embodiment.

### DETAILED DESCRIPTION OF THE PREFERRED EMBODIMENTS

### First Embodiment

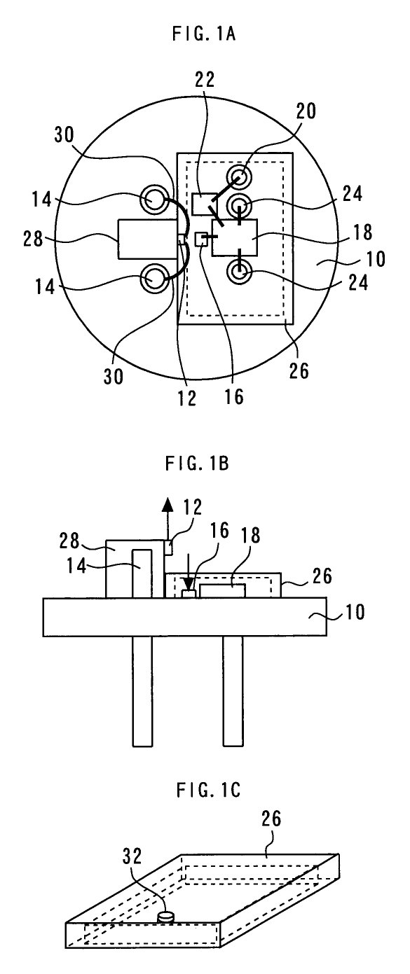

FIG. 1 is a diagram illustrating an optical transceiver module according to a first embodiment of the present invention.

Referring to FIG. 1, a stem 10 is a grounded metal member. A metal member 28 for mounting a light emitting device thereon is mounted on the stem 10. As shown in FIG. 1B, an light emitting device 12 is disposed on almost upper edge portion of the light-emitting device mounting member 28. The light emitting device 12 is connected to two light-emitting device power supply pins 14 by lead wires 30. The two light-emitting device power supply pins 14 are used to supply an input signal to the light emitting device 12. The light-emitting device power supply pins 14 are fixed to the stem 10 by frit glass.

A photodetector 16 is also mounted on the stem 10. As shown in FIG. 1B, the photodetector 16 is disposed substantially immediately below the light emitting device 12. The photodetector 16 is connected to a preamp IC 18 which in turn is connected to two photodetector output pins 24 on the respective sides thereof. The photodetector output pins 24 are fixed to the stem 10 by frit glass. A capacitor 22 is connected to the above preamp IC 18. It is a decoupling capacitor used to supply stable power to the preamp IC 18. This capacitor is also connected to a preamp IC power supply pin 20 to receive power. The preamp IC power supply pin 20 is fixed to the stem 10 by frit glass.

A shielding member 26 as shown in FIG. 1C is mounted on the stem 10. It is made of a metal and is electrically coupled to the stem 10 which is grounded. The shielding member 26 has a pinhole 32 to provide an optical path for the received beam. According to the present embodiment, the pinhole 32 has a diameter of 100 μm.

The diameter of the pinhole 32 is preferably large enough to allow the (entire) received beam to reach the photodetector 16. The received beam has a divergence angle of approximately 8 degrees. According to the present embodiment, the light receiving surface of the photodetector 16 is spaced a distance of 0.3 mm from the inner surface of the top wall of the shielding member 26, as shown in FIG. 1B. In this case, the minimum required diameter of the pinhole 32 is 84 μm. In this example, the diameter of the pinhole 32 is 100 μm, as described above, to accommodate process variations. This arrangement of the present embodiment prevents the photodetector 16 from receiving unwanted light (i.e., light other than the beam received from the optical fiber).

The shielding member 26 is provided to isolate the components on the light receiving side from those on the light emitting side, namely, the light emitting device 12, the light-emitting device power supply pins 14, and the lead wires 30, to prevent electrical interference. Specifically, according to the present embodiment, the shielding member 26 is disposed to cover the photodetector 16, the preamp IC 18, the photodetector output pins 24, the capacitor 22, and the preamp IC power supply pin 20.

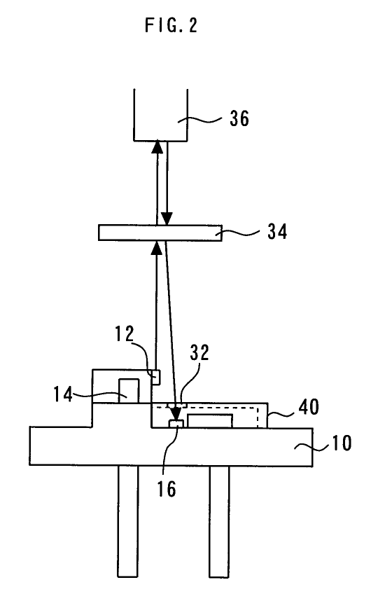

FIG. 2 is a diagram showing an exemplary configuration in which the optical transceiver module shown in FIG. 1 is used for optical communications. This configuration includes a diffraction grating 34 that has a function to cause one wavelength λ₁ of light to travel straight and to diffract another wavelength λ₂ of light at an angle, which is referred to as a “diffraction angle.” According to the present embodiment, the diffraction angle of the diffraction grating 34 (at the wavelength λ₂) is smaller than 90 degrees, namely approximately 10 degrees. As shown in FIG. 2, an optical fiber 36 is disposed above the diffraction grating 34. Although an optical communications system basically includes a lens(es) to collimate light, a description thereof will not be provided herein for brevity.

The operation of the optical transceiver module of the present embodiment will now be described. The light emitting device 12 emits a transmission beam of wavelength λ₁. This transmission beam (of wavelength λ₁) enters the diffraction grating 34 and propagates straight through the gating. After passing through the diffraction grating 34, the transmission beam (of wavelength λ₁) enters an optical fiber 36 at an end face thereof. On the other hand, a received beam of wavelength λ₂ is emitted from the same end face of the optical fiber 36. When the received beam (of wavelength λ₂) passes through the diffraction grating 34, the received beam (of wavelength of λ₂) is diffracted and hence its travel direction is changed by an angle corresponding to the above diffraction angle of the diffraction grating 34. The optical system shown in FIG. 2 is configured such that the diffracted received beam (of wavelength of λ₂) passes through the pinhole 32 to reach the photodetector 16. Thus, the photodetector 16 can receive the received beam of wavelength λ₂ from the optical fiber 36. In this way, the system shown in FIG. 2 provides single-fiber bidirectional communications.

In an optical transceiver module, the power ratio of the signal (or light) emitted from the light emitting device 12 relative to the signal (or light) input to the photodetector 16 is high (approximately 50 dB). As a result, the high power signal input to the light emitting device 12 interferes with the signal output from the photodetector 16. (This interference is referred to as “crosstalk.”) One factor in causing such crosstalk is spatial coupling between electromagnetic fields. An effective method for controlling, or reducing, crosstalk is to cover the photodetector 16 with a grounded metal member to shield the photodetector output signal from external electromagnetic waves.

In the optical transceiver module of the present embodiment, the electromagnetic waves emitted from the light-emitting device power supply pins 14 and the lead wires 30 may cause crosstalk. It should be noted that reducing the distance between the light emitting device 12 and the photodetector 16 results in a reduction in the distances between the photodetector 16 and the light-emitting device power supply pins 14 and the lead wires 30, leading to increased crosstalk. Therefore, in order to reduce crosstalk, the light emitting device 12 must be spaced a sufficient distance apart from the photodetector 16. On the other hand, to reduce the component mounting space, the light emitting device 12 and the photodetector 16 are preferably disposed in close proximity. In the optical transceiver module of the present embodiment, the photodetector 6, etc. are enclosed within the shielding member 26, which allows the light emitting device 12 and the photodetector 16 to be disposed in close proximity (that is, allows reduction of the component mounting space) while reducing crosstalk.

Although in the optical transceiver module of the present embodiment the shielding member 26 covers not only the photodetector 16 but also the capacitor 22, the photodetector output pins 24, the preamp IC power supply pin 20, and the preamp IC 18, the present invention is not limited to such a configuration. For example, in the case of an optical transceiver module in which capacitors and ICs are not disposed on the stem 10, only the photodetector 16 and the components around it may be covered with the shielding member 26.

Further, although the diffraction grating 34 shown in FIG. 2 has been described as having a diffraction angle of 10 degrees (at wavelength λ₂), it may have any diffraction angle less than 90 degrees, as described above, which still results in reduced component mounting space.

### Second Embodiment

A second embodiment of the present invention provides an optical transceiver module that has smaller component mounting space than the optical transceiver module of the first embodiment.

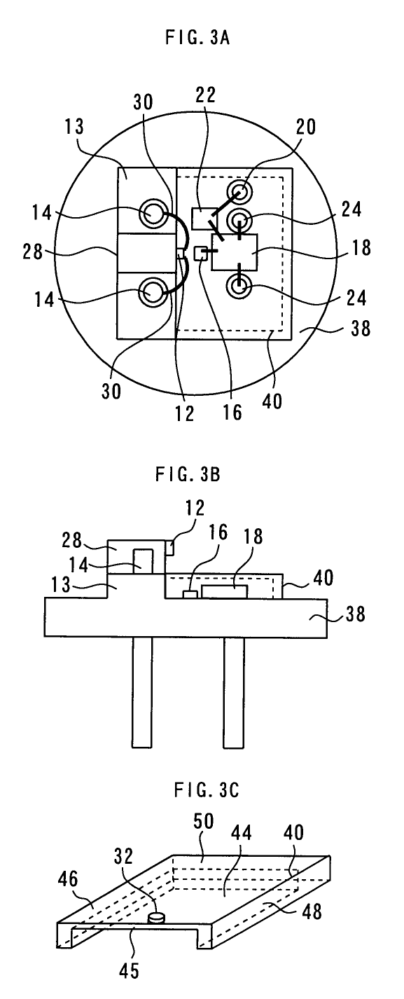

FIG. 3 shows an optical transceiver module of the present embodiment. This optical transceiver module differs from that of the first embodiment in that it includes a stem 38 and a shielding member 40 instead of the stem 10 and the shielding member 26. The stem 38 is a grounded metal member and has upwardly protruding stem protrusions 13, as shown in FIG. 3B. Each stem protrusion 13 surrounds a respective light-emitting device power supply pin 14 and has a height equal to or greater than the thickness of the shielding member. This means that the circumferential surfaces of the light-emitting device power supply pins 14 are covered with a thicker metal than the circumferential surfaces of the photodetector output pins 24. It should be noted that the surfaces of the stem protrusions 13 in contact with the shielding member 40 form a flat plane together with the surface of the light-emitting device mounting member 28 on which the light emitting device 12 is mounted.

The shielding member 40 has a top surface 44 and three side surfaces 46, 48, and 50, as shown in FIG. 3C. Each side surface 46, 48, 50 meets the top surface 44. The shielding member 40 also has a pinhole 32, which has the same dimensions as described in connection with the first embodiment. The shielding member 40 is mounted on the stem 38 such that an open side 45 of the shielding member 40 is in contact with the stem protrusions 13, and the shielding member 40 covers the photodetector 16, the photodetector output pins 24, the preamp IC 18, the preamp IC power supply pin 20, and the capacitor 22. Thus, the shielding member 40 is electrically coupled to the stem 38 which is grounded.

The optical transceiver module of the present embodiment operates in the same manner as the optical transceiver module of the first embodiment.

In the case of an optical transceiver module having a restricted component mounting space, the light emitting device 12 and the photodetector 16 must be disposed in close proximity, which may prevent the shielding member 26 of the first embodiment from being mounted on the stem. Even in such a case, the shielding member 40 of the present embodiment may be able to be mounted on the stem, since the side (45) of the shielding member 40 facing the stem protrusions 13 has no side wall, that is, the open side 45 of the shielding member 40 is in contact with the stem protrusions 13. Thus, the shielding member 40 allows the light emitting device 12 and the photodetector 16 to be disposed closer to each other, as compared to the shielding member 26 of the first embodiment.

According to the present embodiment, the stem protrusions 13 block the propagation of the electromagnetic waves emitted from the light-emitting device power supply pins 14. Further, the shielding member 40 and the stem protrusions 13, which together cover the photodetector 16, etc., block the electromagnetic waves emitted from the lead wires 30. In this way, the shielding member 40 and the stem protrusions 30 prevent crosstalk between the input and output electrical signals. Thus, like the optical transceiver module of the first embodiment, this optical transceiver module exhibits reduced crosstalk.

While the optical transceiver module of the present embodiment has been described as including the shielding member 40, this member may be omitted where the electromagnetic waves emitted from the lead wires 30 are of low intensity, since in such a case it is sufficient that the stem protrusions 13 block the electromagnetic waves emitted from the light-emitting device power supply pins 14.

### Third Embodiment

A third embodiment of the present invention provides an optical transceiver module that exhibits lower optical crosstalk than the optical transceiver module of the second embodiment.

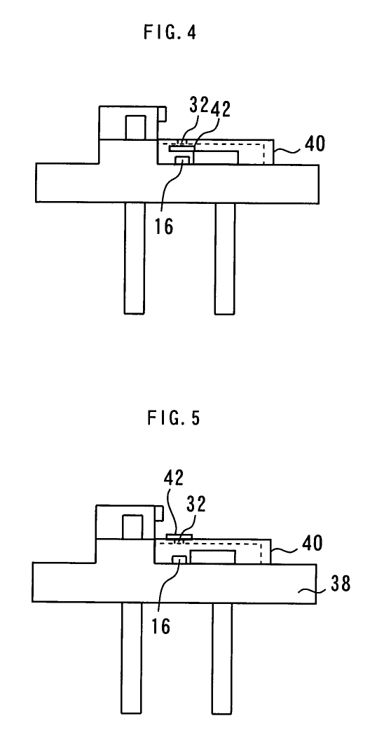

FIG. 4 is a diagram showing an optical transceiver module of the present embodiment. This optical transceiver module differs from that of the second embodiment in that it additionally includes a dielectric multilayer film filter 42. The dielectric multilayer film filter 42 has a function to transmit only a particular wavelength of light. Specifically, according to the present embodiment, the dielectric multilayer film filter 42 allows only the received beam (of wavelength λ₂) to pass through. This filter exhibits lower filtering performance when filtering light incident at different angles than that of the received beam (of wavelength λ₂). Further, it has a thin plate-like structure so that it can be mounted within the shielding member 40.

The dielectric multilayer film filter 42 is disposed within the shielding member 40 such that it is located immediately above the photodetector 16. According to the present embodiment, the received beam passes through this filter before entering the photodetector 16.

The optical transceiver module of the present embodiment operates in the same manner as the optical transceiver module of the first embodiment.

In the case of a single-package optical transceiver module containing both the light emitting device 12 and the photodetector 16, unwanted light generated from the light emitting device 12 may reach the photodetector 16, which may result in interference with the received beam incident to the photodetector 16. (This interference is referred to as “optical crosstalk.”) To prevent this, the optical transceiver module of the present embodiment includes the dielectric multilayer film filter 42 disposed immediately above the photodetector 16, as described above, to prevent unwanted light from entering the photodetector 16. Since the dielectric multilayer film filter 42 is mounted within the shielding member 40 (as described above), only light that has passed through the pinhole 32 enters the filter. That is, only light in a limited range of incident angles reaches the dielectric multilayer film filter 42, allowing the filter to properly function. Thus, the optical transceiver module of the present embodiment includes the dielectric multilayer film filter 42 to prevent unwanted light from entering the photodetector 16 and thereby reduce optical crosstalk.

### Fourth Embodiment

A fourth embodiment of the present invention provides an optical transceiver module in which the dielectric multilayer film filter 42 can be more easily mounted, as compared to the optical transceiver module of the third embodiment.

FIG. 5 is a diagram showing an optical transceiver module of the present embodiment. This optical transceiver module differs from that of the third embodiment in that the dielectric multilayer film filter 42 is mounted at a different location. Specifically, according to the present embodiment, the dielectric multilayer film filter 42 is disposed on the top surface of the top wall of the shielding member 40, immediately above the pinhole 32. It is fixed to the shielding member 40 by an adhesive. This arrangement allows the received beam to pass through the dielectric multilayer film filter 42 before entering the photodetector 16. The dielectric multilayer film filter 42 reduces optical crosstalk, as in the third embodiment.

The optical transceiver module of the present embodiment operates in the same manner as the optical transceiver module of the first embodiment.

In fabrication of the optical transceiver module of the third embodiment, the dielectric multilayer film filter 42 must be bonded to the shield member 40 before the shield member 40 is fixed to the stem 38, since the dielectric multilayer film filter 42 is disposed within the shield member 40. It should be noted that soldering is the easiest way to fix the shielding member 40 to the stem 38. However, in the case of the optical transceiver module of the third embodiment, such soldering may cause thermal damage to the dielectric multilayer film filter 42, resulting in degraded filtering characteristics. In the case of the optical transceiver module of the present embodiment, on the other hand, since the dielectric multilayer film filter 42 is disposed on the exterior of the shielding member 40, it can be bonded to the shielding member 40 after the shield member 40 is soldered to the stem 38, thus avoiding causing thermal damage to the dielectric multilayer film filter 42.

Thus, the present invention allows an optical transceiver module to exhibit reduced crosstalk between the input and output signals without increasing its component mounting space.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2007-028551, filed on Feb. 7^{th} 2007 including specification, claims, drawings and summary, on which the Convention priority of the present application is based, are incorporated herein by reference in its entirety.

What is claimed is:

1. An optical transceiver module comprising:
a light emitting device;
a photodetector; and
a grounded metal member covering said photodetector and having a hole for providing an optical path for a received beam, said optical path extending between a light receiving point of said photodetector and a predetermined point along an optical path traveled by a beam emitted from said light emitting device;
wherein said optical path extending between said light receiving point and said predetermined point forms an angle of less than 90 degrees with respect to said optical path traveled by said beam emitted from said light emitting device.

2. The optical transceiver module according to claim 1, further comprising:
a metal pin through which said light emitting device receives an input signal; and
a metal pin through which an output signal from said photodetector is received;
wherein said metal pin through which said light emitting device receives said input signal is covered with a thicker metal than said metal pin through which said output signal from said photodetector is received.

3. The optical transceiver module according to claim 1 further comprising:
a dielectric multilayer film filter transmitting only a particular wavelength, said dielectric multilayer film filter being disposed within said grounded metal member such that said optical path for said received beam passes through said dielectric multilayer film filter.

4. The optical transceiver module according to claim 2 further comprising:
a dielectric multilayer film filter transmitting only a particular wavelength, said dielectric multilayer film filter being disposed within said grounded metal member such that said optical path for said received beam passes through said dielectric multilayer film filter.

5. The optical transceiver module according to claim 1, further comprising:
a dielectric multilayer film filter transmitting only a particular wavelength, said dielectric multilayer film filter being disposed on the exterior of said grounded metal member such that said optical path for said received beam passes through said dielectric multilayer film filter.

6. The optical transceiver module according to claim 2, further comprising:
a dielectric multilayer film filter transmitting only a particular wavelength, said dielectric multilayer film filter being disposed on the exterior of said grounded metal member such that said optical path for said received beam passes through said dielectric multilayer film filter.

7. An optical transceiver module comprising:
a metal pin through which a light emitting device receives an input signal; and
a metal pin through which a light-receive-side signal passes;
wherein said metal pin through which said light emitting device receives said input signal and said metal pin through which said light-receive-side signal passes penetrate through a metal stem; and
wherein the circumferential surface of said metal pin through which said light emitting device receives said input signal is covered with a thicker material than the circumferential surface of said metal pin through which said light-receive-side signal passes.
